(19) United States
(12) Patent Application Publication
(10) Pub. No.: US 2021/0158735 A1
(43) Pub. Date: May 27, 2021

(54) DRIVING DEVICE AND DRIVING METHOD OF DISPLAY PANEL

(71) Applicants: HKC Corporation Limited, Shenzhen, Guangdong (CN); Chongqing HKC Optoelectronics Technology Co., Ltd., Chongqing (CN)

(72) Inventor: Yunchuan Hu, Chongqing (CN)

(21) Appl. No.: 16/315,742

(22) PCT Filed: Dec. 12, 2017
(86) PCT No.: PCT/CN2017/115739

§ 371 Date: Jan. 7, 2019

(30) Foreign Application Priority Data
Oct. 24, 2017 (CN) 201711007738.0

(51) Int. Cl. G09G 3/20

(52) U.S. Cl. CPC G09G 3/20; G09G 2370/08; G09G 2310/08

(57) ABSTRACT

A driving device and a driving method of a display panel. The driving device includes: a system-on-chip, configured to receive an image data signal to be transmitted and to output the image data signal to be transmitted; a timing controller, configured to receive the image data signal to be transmitted output from the system-on-chip, and output the image data signal to be transmitted after extension; the timing controller is further configured to produce a control signal to control a gate driver and output the control signal; and the gate driver and a source driver, the gate driver is configured to turn on simultaneously a plurality of scanning lines according to the control signal; the source driver is configured to drive respectively a pixel unit connected with the turned on scanning lines according to the extended image data signal, and extended image data signal is displayed after line and column extension.

### TECHNICAL FIELD

The present application relates to the technical field of display, and in particular to a driving device and a driving method of a display panel.

### BACKGROUND

With booming development of Thin Film Transistor-Liquid Crystal Display (TFT-LCD), 4K High Definition and above have become a mainstream display in the industry. In order to maximize profits, display panel manufacturers usually display the Ultra High Definition (MD) panel by adjusting the Full High Definition (FHD) input signal via the System-on-chip (SOC). The SOC processes input signal through a line expansion module and a column expansion module. The data volume after the line expansion module has become twice as large after processing, and afterwards the data volume after the column expansion module is 4 times as large compared to the original. The carried out data is transmitted to the Timing controller (TCON), who then transmits the received data to a gate driver and a source driver. The Gate driver is responsible for opening of the Thin Film Transistor (TFT) under function of control data. And the source driver is responsible for writing the data which requires displaying, to a pixel unit when the TFT is turned on. This processing with vast amount of data volume will increase the burden of the ICON, and further increase the cost induced by consumption of internal storage resources and logic resources of the SOC.

### SUMMARY

The present application aims to provide a driving device and a driving method of a display panel, which solves the problem of an increased burden for TCON after the SOC processes extension to the image data signal to be transmitted, as well as consumption of the storage resource and the logic resource inside the SOC.

To fulfill such an intention, the present application provides a driving device. The driving device includes:

a system-on-chip, configured to receive an image data signal to be transmitted and to output the image data signal to be transmitted;

a timing controller, configured to receive the image data signal to be transmitted output from the system-on-chip, and to extend and output the image data signal to be transmitted; the timing controller is further configured to produce a control signal to control a gate driver and output the control signal; and

the gate driver and a source driver. The gate driver is configured to turn on simultaneously a plurality of scanning lines according to the control signal; the source driver is configured to chive respectively a pixel unit connected with the turned on scanning lines according to the extended image data signal, and extended image data signal is displayed after line extension and column extension.

Optionally, the time controller receives the image data signal to be transmitted output from the system-on-chip, and outputs the image data signal to be transmitted after the line extension.

Optionally, the timing controller includes: a line extraction module, configured to extract data of each line of the image data signal to be transmitted, when the image data signal to be transmitted is received.

Optionally, the timing controller further includes: an extension module which is configured to process the line extension to data of each line of the extracted image data signal to be transmitted.

Optionally, extension is carried out to the data of each line of the extracted image data signal by the extension module via copying or interpolating.

Optionally, double extension is carried out to the data of each line of the extracted image data signal by the extension module via copying or interpolating.

Optionally, the gate driver is configured to turn on two scanning lines according to the control signal.

Optionally, the gate driver is configured to turn on two adjacent scanning lines according to the control signal.

Optionally, the scanning lines are a plurality of scanning line pairs that are arranged in sequence.

Optionally, the system-on-chip is configured to receive an image signal, convert the image signal in a format compatible for the time controller, and to output the image signal to the time controller.

Furthermore, to fulfill the above-mentioned objectives, the present application provides a driving method of the display panel. The method includes the following steps:

receiving an image data signal to be transmitted by a system-on-chip and outputting the image data signal to be transmitted;

receiving the image data signal to be transmitted output from the system-on-chip by a timing controller, outputting the image data signal to be transmitted after extension; wherein the timing controller produces a control signal for controlling a gate driver and outputs the control signal;

turning on simultaneously a plurality of scanning lines according to the control signal by the gate driver; driving respectively a pixel unit connected with the turned on scanning lines according to the extended image data signal by the source driver, allowing the extended image data signal to be displayed after line extension and column extension.

Optionally, receiving the image data signal to be transmitted output from the system-on-chip by the time controller, and outputting the image data signal to be transmitted after extension, specifically includes:

receiving the image data signal to be transmitted output from the system-on-chip by the time controller, and outputting the image data signal to be transmitted after line extension.

Optionally, receiving the Image data signal to be transmitted output from the system-on-chip by the time controller, and outputting the image data signal to be transmitted after extension; specifically includes:

extracting data of each line of the image data signal to be transmitted by the timing controller, when the image data signal to be transmitted is received by the timing controller.

Optionally, the time controller includes an extension module.

Receiving the image data signal to be transmitted output from the system-on-chip by the time controller, and outputting the image data signal to be transmitted after extension, specifically includes:

processing extension to data of each line of the extracted image data signal to be transmitted by the extension module.

Optionally, processing extension to the data of each line of the extracted image data signal to be transmitted by the extension module, specifically includes:

processing double extension to the data of each line of the extracted image data signal to be transmitted by the extension module.

Optionally, turning on simultaneously a plurality of scanning lines according to the control signal by the gate driver, specifically includes:

turning on simultaneously two scanning lines according to the control signal by the gate driver.

Optionally, turning on simultaneously two scanning lines according to the control signal by the gate driver, specifically includes:

turning on simultaneously two adjacent scanning lines according to the control signal by the gate driver.

Optionally, turning on simultaneously two scanning lines according to the control signal by the gate driver, specifically includes:

enabling the scanning lines to be a plurality of scanning line pairs that are arranged in sequence.

Optionally, receiving an image data signal to be transmitted by a system-on-chip and outputting the image data signal to be transmitted, specifically includes:

receiving an image signal, converting the image signal in a format compatible for the time controller, and outputting the image signal to the time controller by the system-on-chip.

Furthermore, to fulfill the above-mentioned objectives, the present application further provides a driving method. The method includes the following steps:

receiving a full high definition image data signal by a system-on-chip and outputting the full high definition image data signal to be transmitted;

receiving the full high definition image data signal output from the system-on-chip by the timing controller, extracting data of each line of the full high definition image data signal and calling for an extension module; transmitting the data of each line of the full high definition image data to the extension module, so that the data of each line of the full high definition image data is output after double extension by the extension module via copying and interpolating; the timing controller produces a control signal to control the gate driver and outputs the control signal;

turning on simultaneously two adjacent scanning lines according to the control signal by the gate driver; driving respectively a pixel unit connected with the turned on two adjacent scanning lines according to the full high definition image data signal after line extension by the source driver; allowing the full high definition image data signal to be displayed as an ultra high definition image data signal after the line extension.

The driving device provided in the present application, saves the storage resources and the logical resources inside the SOC and further saves the cost regarding resolution conversion operation; by means of processing the image data signal to be transmitted by the timing controller, and turning on at least two adjacent scanning lines via controlling the gate driver.

### DESCRIPTION OF THE DRAWINGS

FIG. 1 is an exemplary structural flow diagram of converting the full high definition signal to the ultra high definition signal via the system-on-chip;

FIG. 2 is an exemplary structural flow diagram of internal signal processing of the system-on-chip;

FIG. 3 is a structural schematic diagram of an exemplary embodiment of the driving device of the present application;

FIG. 4 is a sequence diagram of the driving method in an exemplary embodiment of the present application;

FIG. 5 is a structural schematic diagram of another exemplary embodiment of the driving device of the present application;

FIG. 6 is a flow chart showing the data processing inside the timing controller of an exemplary embodiment of the present application;

FIG. 7 is a comparison diagram showing the data inside the timing controller before and after extension in an exemplary embodiment of the present application;

FIG. 8 is a flow diagram of an exemplary embodiment of the driving method of the display panel of the present application;

FIG. 9 is a flow diagram of another exemplary embodiment of the driving method of the display panel of the present application.

The implementation, functional features and advantages of the present application will be further described with the reference to the drawings.

### DETAILED DESCRIPTION OF THE EMBODIMENTS

The technical solutions in the embodiments of the present application are clearly and completely described in the following with reference to the drawings in the embodiments of the present application. It is obvious that the described embodiments are only a part of the embodiments of the present application, and not all of the embodiments. All other embodiments conceived by those skilled in the art based on the embodiments of the present application without creative labor, shall be included in the protection scope of the present application.

It should be noted that all directional indications (such as up, down, left, right, front, back and etc.,) in the embodiments of the present application are only used to explain relative positional relationship, motion situation, etc., under a certain posture (for example, as shown in the drawing). If the specific posture changes, the directional indication should also changes accordingly.

In addition, the descriptions of “first”, “second”, and the like in this application are used for the purpose of description only, and are not to be construed as indicating or implying their relative importance or implicitly indicating the number of technical features being indicated. Thus, features defining with “first” or “second” may include at least one of these features, either explicitly or implicitly. In addition, the technical solutions between the various embodiments may be combined; but the combination must be based on the implementation by those skilled in the art. When the combination of the technical solutions is contradictory or impossible to implement, it should be considered that the combination of the technical solutions does not exist, and of course beyond the protection scope required by the present application.

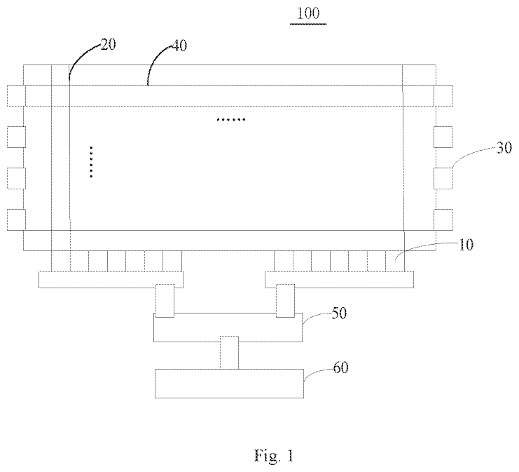

Referring to FIG. 1, which shows a structural flow diagram of converting the FHD to the UHD via the SOC. The driving device 100 includes a source driver 10, providing a plurality of source driving channels to connect with a plurality of data wires 20; a gate driver 30 providing a plurality of gate driving channels to connect with a plurality of scanning lines 40; a timing controller board 50 electrically connected to the source driver 10 and the gate driver 30 for receiving image data, and for outputting the received image data to the source driver 10, and for controlling the gate driver 30 to turn on the scanning lines in sequence; a system-on-chip 60 electrically connected to the timing controller board 50 to receive an image signal; and to process the image signal by line extension and column extension. For example; the FHD signal is converted into a UHD signal by the line extension and the column extension, and then the UHD signal is transmitted to the timing controller board 50.

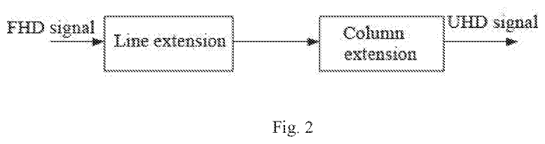

FIG. 2 is an exemplary structural flow diagram of internal signal processing of the system-on-chip. For example, the ultra high definition signal is obtained by processing the full high definition with the line extension module and the column extension module.

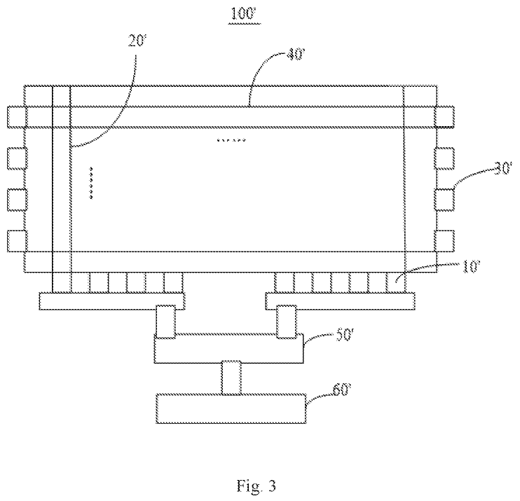

Referring to FIG. 3, which is a structural schematic diagram of an exemplary embodiment of the driving device 100′ of the present application. The driving device 100′ includes a gate source driver 10′, providing a plurality of source driving channels to correspondingly connect with a plurality of data wires 20′; a gate driver 30′, providing a plurality of gate driving channels to connect with a plurality of scanning lines 40′; the plurality of scanning lines 40′ are a plurality of scanning line pairs that are arranged in sequence.

The system-on-chip 60′, is configured to receive an image data signal to be transmitted and to output the image data signal to be transmitted;

A timing controller 50′, configured to receive the image data signal to be transmitted output from the system-on-chip 60′, and to output the image data signal to be transmitted after extension. The timing controller 50′ is further configured to produce a control signal to control a gate driver 30′ and output the control signal;

A gate driver 30′, which is configured to turn on singly a plurality of adjacent scanning lines according to the control signal; and

A source driver 10′, which is configured to process the column extension to the image data signal and display extended image data signal, through the plurality of scanning lines which are turned on singly in sequence.

It has to be noted that, the timing controller 50′, connected electrically with the source driver 10′ and the gate driver 30′, is configured to process the line extension to the image data signal to be transmitted after receiving the image data signal to be transmitted, and to output the image data signal after line extension to the source gate 10′, and to control the gate driver 30′ to turn on the plurality of scanning lines 40′ in sequence, so that the image data signal after line extension is carried out with the column extension. The timing controller 50′, is configured to process the image data signal to be transmitted with line extension, after receiving the image data signal to be transmitted, and to output the extended image data signal to the source driver 10′. The timing controller 50′ is further configured to control the gate driver 30′ to turn on simultaneously a plurality of scanning lines according to the control signal. The source driver 10′ is configured to drive respectively a pixel unit connected with the plurality of scanning lines according to the extended image data signal, allowing the extended image data signal to be displayed after line extension and column extension. In the present exemplary embodiment, the plurality of scanning lines are two scanning lines.

In the present application, the driving device 100′ is applicable but not limited for the panel displayed by FHD, for example, a UHD panel displayed with 8K.

The timing controller 50′ is further configured to extract data of each line of the image data signal to be transmitted, when the image data signal to be transmitted is received by the timing controller, and to output the carried out image data to the source driver. It is understandable that the timing controller 50′, processes the image data signal to be transmitted with line extension after receiving the image data signal to be transmitted, and outputs the image data after extension to the source driver 10′. The line extension could be a line doubling, which processes the image data signal to be transmitted with line extension. Thus, data processing burden is reduced for the timing controller 50′.

In order to achieve the line extension, the full high definition is converted into ultra high definition in the present application, taking double extension for example.

It has to be noted that, the timing controller 50′ is configured to receive the image data signal to be transmitted after carried out by the system-on-chip, and to process and convert the image data signal to be transmitted to the image data, so that the image data can be compatible for different display screens with different resolution.

The gate driver 30′, provides a plurality of source driving channels to correspondingly connect with a plurality of scanning lines 40′; the number of the scanning lines is plural, but not limited to the scanning lines 40′ in the drawings. Therefore, an ellipsis is illustrated herein.

The gate driver 30′ is configured to receive a first control data of the timing controller 50′, and turn on in sequence a preset number of scanning lines 40′ in pairs.

The gate driver 30′ could be provided at one side of the driving device 100′ and could receive the control data the timing controller transmits. The gate driver 30′ generates a driving voltage for driving the thin film transistor, and the thin film transistor is turned on by the driving voltage. The source of the thin film transistor is connected to the source driver 10′, whereas the gate of the thin film transistor is connected to the gate driver 30′ which controls the pixel unit connected to the gate driver 30′.

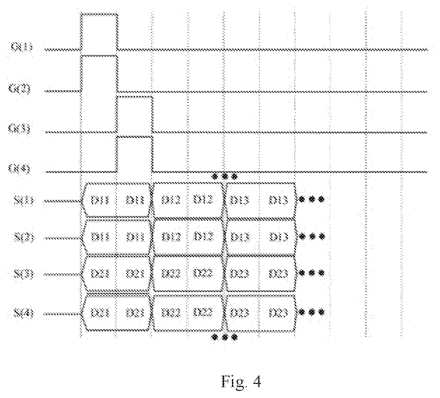

The gate driver 30′ can receive the control data transmitted by the timing controller 50′, and simultaneously turns on the plurality of pairs of scanning lines 40′ via the control data. In this embodiment, taking one pair of scanning lines 40′ opened for example, as shown in FIG. 4 which is a timing diagram of a driving mode according to an exemplary embodiment of the present application. During a preset time, the gate driver 30′ simultaneously turns on the scan lines 40′, G(1) and G(2) under the function of the control data, and in the next moment, G(1) and G(2) are simultaneously turned off, and G(3) and G(4) are turned on simultaneously.

The source driver 10′, provides a plurality of source driving channels to correspond to a plurality of data wires 20′. The source driver 10′ controls a plurality of data wires 20′. The number of the data wires is plural, but not limited to the data wires 20′ shown in the drawings. Therefore, an ellipsis is illustrated herein.

The gate driver 10′ of the driving device 100′, displays the image data, according to the turned on scanning lines 40′.

The driving device further includes a pixel unit (not shown in the drawings). The pixel unit is electrically connected with the source driver 10′ and the gate driver 30′. The source driver 10′ is configured to receive a second control data of the timing controller 50′, and control the pixel unit to produce corresponding display, according to the second control data.

The gate source driver 30′ is further configured to turn on singly two adjacent scanning lines according to the control signal.

The source driver 10′ controls the pixel unit to display, according to the two adjacent scanning lines, so that the image data could be carried out with column extension according to two adjacent scanning lines 40′.

The timing controller 50′ could transmit the image data to the source driver 10′, and turn on simultaneously at least one pair of scanning lines 40′. The source driver 10′ could control the corresponding pixel unit to produce a display, according to the control data.

As shown in FIG. 4 again, in the preset time, G(1) and G(2) are simultaneously turned on, and the source driver 10′ can control the corresponding pixel unit to process corresponding display according to the control data. The pixel unit is connected to the turned-on gate driver 30′. When, for example, G(1) and G(2) are simultaneously turned on, the source driver 10′ receives the image data S(1)′ (not shown in the figures), and controls the corresponding pixel unit to display by the control data. When G(3) and G(4) are simultaneously turned on, the source driver 10′ receives the S(3)′ (not shown in the figures) image data, and controls the corresponding pixel unit to produce a display by the control data. D11 represents image data of the first line the first column, and Dij represents image data written in the i-th line the j-th column, and S(1) to S(4) are image data that have been carried out. It is known that the image data signal to be transmitted after processing is display data that achieves the effect of line extension and column extension.

The gate driver 30′ is configured to receive a first control data of the timing controller 50′ transmitted, and turn on in sequence a preset number of scanning lines 40′ in pairs.

The gate driver 10′ could be configured to receive the image data transmitted by the timing controller 50′, and display the image data, according to the simultaneously turned-on pair of scanning lines 40′.

The gate driver 30′ could receive the control data transmitted by the timing controller 50′. The control data could be opening of one pair of scanning lines 40′ which is positioned on the driving device 100′. The present exemplary embodiment takes turning on one pair of scanning lines 40′ simultaneously as the example. A pair of scanning lines are turned on simultaneously, according to the control data transmitted by the timing controller 50′. The gate driver 30′ receives the control data of turning on the pair of scanning lines transmitted by the timing controller. The pair of scanning lines are turned on simultaneously according to the control data.

The timing controller 50′ could transmit the control data to the gate driver 30′. The control data could be a timing signal. The gate driver 30′ converts the timing signal into a switching signal, according to which the scanning lines 40′ are turned on. The present exemplary embodiment takes turning on one pair of scanning lines 40′ simultaneously as the example. The source driver 10′, via one pair of scanning lines 40′ turned on simultaneously, enables the received image data displayed by the pixel unit corresponding to the pair of scanning lines 40′. Column extension of the image data has thus been carried out, achieving the effect of resolution conversion.

It has to be noted that the source driver 10′ could latch at a regular time and feed inside the source driver 10′ every 6 bits of image data of R (Red), G (Green) and B (blue) signal transmitted by the timing controller 50′. Then the image data is converted into analogue signal by a 6 bit digital-to-analog converter, which is afterwards converted into impedance by an output circuit, to feed the data wires 20′ of the driving device 100′.

The timing controller 50′ could convert the image data signal to be transmitted, the control data, and the timing signal from outside to the image data signal to be transmitted, the control data, and the timing signal compatible for the gate driver 30′.

The plurality of scanning lines 40′ are a plurality of scanning line pairs that are arranged in sequence. It has to be noted that one pair of scanning lines 40′ can be turned on simultaneously in sequence. As shown in FIG. 4, one pair of scanning lines 40′ are turned on as G(1) and G(2). G(1) and G(2) are turned off at a next time and G(3) and G(4) are turned on simultaneously. Since G(1) and G(2) has already been turned on, G(3) and G(4) are turned on simultaneously, so that column data of the image data has been carried out with column extension.

In the present exemplary embodiment, taking opening one pair of scanning lines 40′ as an example. Since the one pair of the scanning lines are turned on simultaneously, the source driver 10′ control the pixel unit to process the display according to the image data. The column data of the image data can be double-extended, for example, an image data of 4K1K can be extended to an image data of 4K2K. The column data of the image data has thus been double-extended.

At least one pair of the scanning lines 40′ are turned on. In the present exemplary embodiment, taking turning on one pair of scanning lines for example, the image data is double-extended on the original basis, achieving the effect of resolution conversion. Takes the timing controller 50′ receiving the image data signal to be transmitted with a resolution of 1920*1080 as an example. In order to achieve super resolution, the full HD signal should be converted into an ultra high definition signal. The present exemplary embodiment the image data signal to be transmitted with a resolution of 1920*1080 is firstly extended for extension by the timing controller 50′, to obtain an image data with a resolution of 3840*1080, thereby reducing the data processing burden of the timing controller 50′. The timing controller board 50′ then transmits the control data of simultaneously turning on two scanning lines 40′, which enables the gate driver 30′ to simultaneously turn on two scanning lines 40′. At the same time, the source driver 10′ displays the corresponding pixel unit according to the image data, thereby amplifying the column data of the image data into twice without changing the line data of the image data. Therefore, the image data with the resolution of 3840*1080 is converted into the image data with the resolution of 3840*2160, achieving the effect of ultra-high resolution conversion.

It has to be noted that the gate driver 30′ may include a gate chip 80 (not shown in the drawings). In the present exemplary embodiment, a gate COF (gate Chip on Flim gate) is taken as an example. The scan line 40′ is electrically connected with the gate COF. One pair of scanning lines 40′ is simultaneously turned on by receiving the control data transmitted by the timing controller 50′. Since the pair of scanning lines 40′ is turned on within a preset time, the image data in each column of is double-extended, improving display quality of the image data.

The source driver 10′ provided in the driving device 100′ of the present exemplary embodiment, provides a plurality of source driving channels to correspond to a plurality of data wires 20′. The gate driver 30′, provides a plurality of source driving channels to correspondingly connect with a plurality of scanning lines 40′. The timing controller 50′, connected electrically with the source driver 10′ and the gate driver 30′, is configured to process the line extension to the image data signal to be transmitted after receiving the image data signal to be transmitted, and to output the image data signal after line extension to the source gate 10′, and to control the gate driver 30′ to turn on the plurality of scanning lines 40′ in sequence, so that the image data signal after line extension is carried out with column extension.

As the image data to be transmitted has been extended via the timing controller 50′ in the present application, and line extension and column extension is not carried out via the SOC board, so that the processing burden of the timing controller is alleviated, saving storage resources and logical resources in the SOC. And an adjacent pair of scanning lines 40′ are turned on via the timing controller 50′, processing the column extension following the line extension. The resolution conversion has been achieved, reducing the operation cost of the resolution conversion.

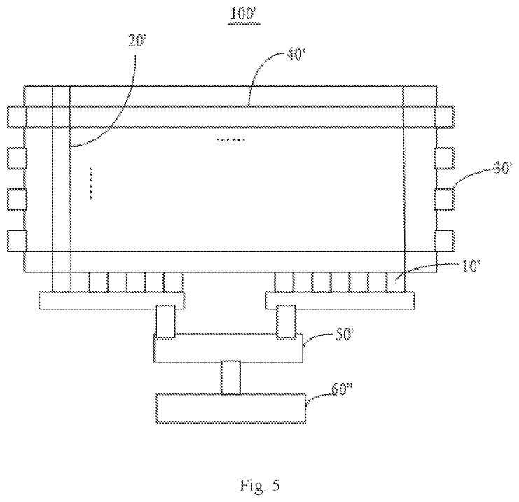

Referring to FIG. 5, which is a structural schematic diagram of another exemplary embodiment of the driving device 100′ of the present application. The driving device further includes a system-on-chip 60′.

The system-on-chip, is configured to receive an image signal, and to convert the image signal in a format compatible for the time controller, and to outputting the image signal to the time controller by the system-on-chip.

The system-on-chip 60′ is configured to process the received image signal, enabling the image signal transmitted via interface devices at different clock domains. The system-on-chip 60′ could be others achieving the same function, with no limitation given herein.

In the present embodiment, the system-on-chip receives FHD full high definition image data, and transmits the full high definition image signal to the timing controller 50′. The timing controller 50′ amplifies the full high definition signal, processing the full high definition image data into 4K1K image data. The timing controller transmits the 4K1K image data to the gate driver 10′ which displays according to the corresponding pixel unit of the image data.

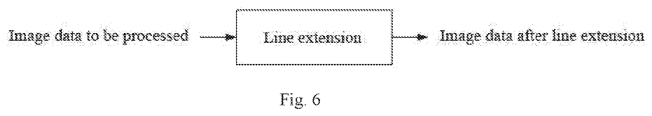

As shown in FIG. 6, which is a flow chart showing the data processing inside the timing controller 50′ of an exemplary embodiment of the present application. That the timing controller 50′ receives image data signal with a resolution of 1920*1.080, is taken as an example. The timing controller board 50′ receives the FHD full HD image data to be transmitted which is transmitted by the system-on-chip 60″. For example, the timing controller 50′ receives the image data signal to be transmitted with a resolution of 1920*1080 which is extended by the timing controller 50′. The image data signal to be transmitted is extended to image data with a resolution of 3840*1080, that is, image data with a resolution of 4K1K. The timing controller board 50′ turned on the gate driver 30′ by the control data, and simultaneously transmits the image data to the source driver 10′. The corresponding pixel unit is displayed according to the image data.

It is understandable that, the image data to be transmitted with a resolution of 1920*1080 is extended to image data with a resolution of 3840*1080 via the timing controller 50′. In the present exemplary embodiment, the full HD signal has been converted into an ultra high definition signal, thereby displaying fulfilled in an ultra high definition. Image data with a resolution of 3840*1080 has been extended to, without expanding the full HD image data to be transmitted into an ultra high definition signal, which reduces data processing burden of the timing board 50′.

It has to be noted that, 720p, 1080i and 1080p are three standard forms for high definition, and 1080p is named as full high definition. Ultra HD is 4K resolution, which is 3840*2160 pixels. It is also suitable for 8K resolution, which is 7680*4320 pixels. It can be seen that the image data with the resolution of 3840*1080 is only full HD image data.

The timing controller 50′ further includes: an extension module (not shown in the drawings), which is configured to process line extension to each line of the extracted image data signal to be transmitted.

Double extension is carried out to each line of the extracted image data signal by the extension module via copying or interpolating.

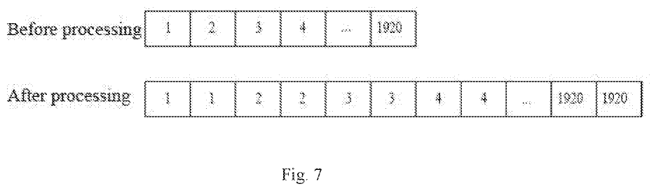

As shown in FIG. 7, which is a comparison diagram showing the data in the timing controller before and after extension. In the present exemplary embodiment, image data signal with a resolution of 1920*1080 is extended to image data signal with a resolution of 3840*1080 via the timing controller 50′. Extension is carried out to data 1920*1080 to be carried out via copying or interpolating. The image data with a resolution of 3840*1080 has been extended to after processing.

It is understandable that, an extension module could be provided in the timing controller 50′, and image data signal to be transmitted could be extended via the extension module.

The extension module could also be provided outside the timing controller. The timing controller 50′ transmits the image data signal to be transmitted to the extension module. The extending module receives the image data signal to be transmitted and processes line extension to the image data signal to be transmitted. The image data after extension is then transmitted to the timing controller 50′.

The extending module is not limited to line extension, which may implement column extension or any other similar functions. No limitation should be given herein.

The timing controller 50′ extends the image data signal to be transmitted in the present exemplary embodiment, without directly processing line extension and column extension by the system-on-chip 60′, which saves the internal storage resources and logical resources, and reduces the processing burden for the timing controller 50′.

Based on the hardware structure mentioned above, exemplary embodiments of the driving method are provided in the present application.

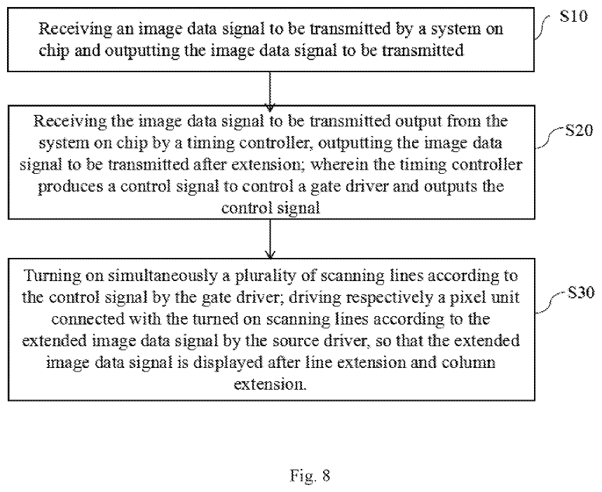

Referring to FIG. 8, which is a flow diagram of a first exemplary embodiment of the driving method of the display panel of the present application.

In some the exemplary embodiments, the driving method of the display panel includes the following steps:

step S10: receiving an image data signal to be transmitted by a system-on-chip and outputting the image data signal to be transmitted;

step S20: receiving the image data signal to be transmitted output from the system-on-chip by a timing controller, outputting the image data signal to be transmitted after extension; wherein the timing controller produces a control signal to control a gate driver and outputs the control signal;

step S30: turning on simultaneously a plurality of scanning lines according to the control signal by the gate driver; driving respectively a pixel unit connected with the turned on scanning lines according to the extended image data signal by the source driver, allowing the extended image data signal to be displayed after line extension and column extension.

The driving device includes a gate source driver, providing a plurality of source driving channels to correspondingly connect with a plurality of data wires; a gate driver, providing a plurality of gate driving channels to connect with a plurality of scanning lines. The plurality of scanning lines are a plurality of scanning line pairs that are arranged in sequence.

The system-on-chip receives an image data signal to be transmitted and to output the image data signal to be transmitted.

The timing controller, connected electrically with the source driver and the gate driver, processes the line extension to the image data signal to be transmitted after receiving the image data signal to be transmitted, and outputs the image data signal after line extension to the source gate, and controls the gate driver to turn on the plurality of scanning lines in sequence, so that the image data signal after line extension is carried out with column extension. The timing controller, processes the image data signal to be transmitted with line extension, after receiving the image data signal to be transmitted, and to output the extended image data signal to the source driver. The timing controller controls the gate driver to turn on simultaneously a plurality of scanning lines according to the control signal; driving respectively a pixel unit connected with the turned on scanning lines according to the extended image data signal by the source driver, so that the extended image data signal is displayed after line extension and column extension.

In the present application, the driving device is applicable but not limited for the panel displayed by FHD, for example, a UHD panel displayed with 8K.

Receiving the image data signal to be transmitted output from the system-on-chip by the time controller, and outputting the image data signal to be transmitted after extension, includes:

receiving the image data signal to be transmitted output from the system-on-chip by the time controller, and outputting the image data signal to be transmitted after line extension.

Further, turning on simultaneously a plurality of scanning lines according to the control signal by the gate driver, specifically includes:

turning on simultaneously two scanning lines according to the control signal by the gate driver.

The timing controller is further configured to extract data of each line of the image data signal to be transmitted, when the image data signal to be transmitted is received by the timing controller, and to output the carried out image data to the source driver. It is understandable that the timing controller, processes the image data signal to be transmitted with line extension, after receiving the image data signal to be transmitted, and outputs the image data after extension to the source driver. The line extension could be a line extension, which processes the image data signal to be transmitted with line extension. Thus, data processing burden is reduced for the timing controller.

In order to achieve the line extension, the full high definition is converted into ultra high definition in the present application, taking double extension for example.

It has to be noted that, the timing controller receives the image data signal to be transmitted after carried out by the system-on-chip, and processes and converts the image data signal to be transmitted to the image data, so that the image data can be compatible for different display screens with different resolution.

The gate driver, provides a plurality of source driving channels to correspondingly connect with a plurality of scanning lines. The number of the scanning lines is plural, but not limited to the scanning lines in the drawings. Therefore, an ellipsis is illustrated herein.

The gate driver receives a first control data of the timing controller, and singly turns on in sequence two adjacent scanning lines in pairs.

The gate driver could be at one side of the driving device and could receive the control data the timing controller transmits. The gate driver generates a driving voltage for driving the thin film transistor, and the thin film transistor is turned on by the driving voltage. The source of the thin film transistor is connected to the source driver, whereas the gate of the thin film transistor is connected to the gate driver which controls the pixel unit connected to the gate driver.

The gate driver can receive the control data transmitted by the timing controller, and simultaneously turn on the plurality of pairs of scan lines via the control data. In this embodiment, taking one pair of scanning lines opened for example, as shown in FIG. 4 which is a timing diagram of a driving mode according to an exemplary embodiment of the present application. During a preset time, the gate driver 30′ simultaneously turns on the scan lines, G(1), and G(2) under the function of the control data, and in the next moment, G(1) and G(2) are simultaneously turned off, and G(3) and G(4) are turned on simultaneously.

The source driver, provides a plurality of source driving channels to correspond to a plurality of data wires. The source driver controls a plurality of data wires. The number of the data wires is plural, but not limited to the data wires shown in the drawings. Therefore, an ellipsis is illustrated herein.

The gate driver of the driving device, displays the image data, according to the turned on scanning lines.

The driving device further includes a pixel unit (not shown in the drawings). The pixel unit is electrically connected with the source driver and the gate driver. The source driver is configured to receive a second control data of the timing controller, and control the pixel unit to produce corresponding display, according to the second control data.

Further, the gate driver turns on simultaneously two scanning lines according to the control signal.

The source driver controls the pixel unit to display, according to the two adjacent scanning lines, so that the image data could be carried out with column extension according to two adjacent scanning lines.

The timing controller could transmit the image data to the source driver, and turn on simultaneously at least one pair of scanning lines. The source driver could control the corresponding pixel unit to produce a display, according to the control data.

As shown in FIG. 4 again, in the preset time, G(1) and G(2) are simultaneously turned on, and the source driver can control the corresponding pixel unit to process corresponding display according to the control data. The pixel unit is connected to the turned-on gate driver. When, for example, G(1) and G(2) are simultaneously turned on, the source driver receives the image data SW′ (not shown in the figures), and controls the corresponding pixel unit to display by the control data. When G(3) and G(4) are simultaneously turned on, the source driver receives the S(3)¹ (not shown in the figures) image data, and controls the corresponding pixel unit to display by the control data. D11 represents image data of the first line the first column, and Dij represents image data written in the i-th line the j-th column, and S(1) to S(4) are image data that have been carried out. It is known that the image data signal to be transmitted after processing is display data that achieves the effect of line extension and column extension.

The gate driver receives a first control data of the timing controller transmitted, and turn on in sequence a preset number of scanning lines in pairs.

The gate driver 10′ could be configured to receive the image data transmitted by the timing controller 50′, and display the image data, according to the simultaneously turned-on pair of scanning lines 40′.

The gate driver could receive the control data transmitted by the timing controller. The control data could be opening of one pair of scanning lines which is positioned in the driving device. The present exemplary embodiment takes turning on one pair of scanning lines 40′ simultaneously as an example. A pair of scanning lines are turned on simultaneously, according to the control data transmitted by the timing controller. The gate driver receives the control data of turning on the pair of scanning lines transmitted by the timing controller. The pair of scanning lines are turned on simultaneously according to the control data.

The timing controller could transmit the control data to the gate driver. The control data could be a timing signal. The gate driver converts the timing signal into a switching signal, according to which the scanning lines are turned on. The present exemplary embodiment takes turning on one pair of scanning lines simultaneously as an example. The source driver enables the received image data displayed by the pixel unit corresponding to the pair of scanning lines 40′ via one pair of scanning lines 40′ turned on simultaneously. Column extension of the image data has thus been carried out, achieving the effect of resolution conversion.

It has to be noted that the source driver could latch at a regular time and feed inside the source driver every 6 bits of image data of R(Red), G(Green) and B(blue) signal transmitted by the timing controller 50′. Then the image data is converted into analogue signal by a 6-bit digital-to-analog converter, which is afterwards converted into impedance by an output circuit, to feed the data wires of the driving device.

The timing controller could convert the image data signal to be transmitted, the control data, and the timing signal from outside to the image data signal to be transmitted, the control data, and the timing signal compatible for the gate driver.

The plurality of scanning lines are a plurality of scanning line pairs that are arranged in sequence. It has to be noted that a pair of scanning lines could be turned on in sequence. As shown in FIG. 4, one pair of scanning lines 40′ are turned on as G(1) and G(2). G(1) and G(2) are turned off at a next time and G(3) and G(4) are turned on simultaneously.

Since G(1) and G(2) has already been turned on, G(3) and G(4) are turned on simultaneously, so that column data of the image data has been carried out with column extension.

In the present exemplary embodiment of the present application, taking a pair of scanning lines turned on as an example, since the one pair of the scanning lines are turned on simultaneously, the source driver control the pixel unit to process the display according to the image data. The column data of the image data can be extended twice, for example, an image data of 4k1k can be extended to an image data of 4k2k. The column data of the image data has thus been extended twice.

At least one pair of the scanning lines are turned on. In the present exemplary embodiment, taking turning on one pair of scanning lines for example, the image data is double-extended on the original basis, achieving the effect of resolution conversion. Takes the timing controller receiving the image data signal to be transmitted with a resolution of 1920*1080 as an example. In order to achieve super resolution, the full HD signal should be converted into an ultra high definition signal. The present exemplary embodiment the image data signal to be transmitted with a resolution of 1920*1080 is firstly extended for extension by the timing controller, to obtain an image data with a resolution of 3840*1080, thereby reducing the data processing burden of the timing controller. The timing controller board then transmits the control data of simultaneously turning on two scanning lines, which enables the gate driver to simultaneously turn on two scanning lines. At the same time, the source driver displays the corresponding pixel unit according to the image data, thereby amplifying the column data of the image data into twice without changing the line data of the image data. Therefore, the image data with the resolution of 3840*1080 is converted into the image data with the resolution of 3840*2160, achieving the effect of ultra-high resolution conversion.

It has to be noted that the gate driver may include a gate chip (not shown in the drawings). In the present exemplary embodiment, a gate COF (gate Chip on Film gate) is taken as an example. The scan line is electrically connected with the gate COF. One pair of scanning lines is simultaneously turned on by receiving the control data transmitted by the timing controller. Since the pair of scanning lines is turned on within a preset time, the image data in each column of is extended twice, improving display quality of the image data.

The source driver provided in the driving device of the present exemplary embodiment, provides a plurality of source driving channels to correspond to a plurality of data wires. The gate driver, provides a plurality of source driving channels to correspondingly connect with a plurality of scanning lines. The timing controller, connected electrically with the source driver and the gate driver, is configured to process the line extension to the image data signal to be transmitted after receiving the image data signal to be transmitted, and to output the image data signal after line extension to the source gate, and to control the gate driver to turn on the plurality of scanning lines in sequence, so that the image data signal after line extension is carried out with column extension.

As the image data to be transmitted has been extended via the timing controller in the present application, and line extension and column extension is not carried out via the SOC board, so that the processing burden of the timing controller is alleviated, saving storage resources and logical resources in the SOC. And an adjacent pair of scanning lines are turned on via the timing controller, processing the column extension following the line extension. The resolution conversion has been achieved, reducing the operation cost of the resolution conversion.

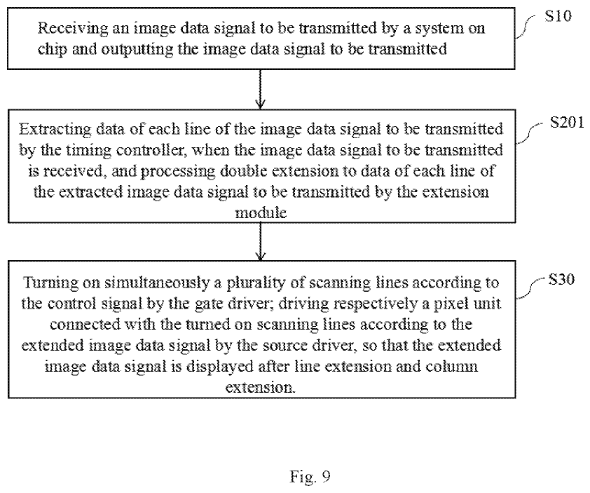

Referring to FIG. 9, which is a flow diagram of a second exemplary embodiment on the basis of FIG. 8 of the driving method of the display panel of the present application. The timing controller includes the extension module.

The step S20, specifically includes:

step S201, extracting data of each line of the image data signal to be transmitted by the timing controller, when the image data signal to be transmitted is received, and processing double extension to data of each line of the extracted image data signal to be transmitted by the extension module.

The timing controller includes the line extension module (not shown in the drawings), and the line extension module extends the image data signal to be transmitted.

Double extension is carried out to data of each line of the extracted image data signal by the extension module via copying or interpolating.

Wherein, the display panel, for example, can be an display panel, an OLED display panel, a QLED display panel, a curved display panel or any other display panels.

It is understandable that, an extension module could be provided in the timing controller, and image data signal to be transmitted could be extended via the extension module.

The extension module could also be provided outside the timing controller. The timing controller transmits the image data signal to be transmitted to the extension module. The extending module receives the image data signal to be transmitted and processes line extension to the image data signal to be transmitted. The image data after extension is then transmitted to the timing controller.

The extending module is not limited to line extension, which may implement column extension or any other similar functions. No limitation should be given herein.

Furthermore, the exemplary embodiment of the present application provides a display device, in which the previously mentioned driving device is included. A structure of the driving device can be referred to the previously mentioned exemplary embodiment. As the driving device could adopt all the technical solution of the exemplary embodiment, the display holds at least the beneficial effect of the previously mentioned technical solution. Further details would not be given herein.

Moreover, the exemplary embodiment of the present application provides a driving method. The driving method includes: receiving a full high definition image data signal by a system-on-chip and outputting the full high definition image data signal to be transmitted;

receiving the full high definition image data signal output from the system-on-chip by the timing controller, extracting data of each line of the full high definition image data signal and calling for an extension module; transmitting the data of each line of the full high definition image data to the extension module, so that the data of each line of the full high definition image data is output after double extension by the extension module via copying and interpolating; wherein the timing controller produces a control signal to control the gate driver and outputs the control signal;

turning on simultaneously two adjacent scanning lines according to the control signal by the gate driver; driving respectively a pixel unit connected with the turned on two adjacent scanning lines according to the full high definition image data signal after line extension by the source driver, so that the full high definition image data signal is displayed as an ultra high definition image data signal after line extension.

As shown in FIG. 4, at the first moment, the first pair of scanning lines G(l) and G(2) are simultaneously at a high level, and the data wire displays the corresponding pixel unit according to the data of S(1)′ (not shown in the FIGS.

At the second moment, the first pair of scanning lines G(3) and G(4) are simultaneously at a high level, and G(1) and G(2) are simultaneously at a low level. The data wire displays the corresponding pixel unit according to the data of S(3)′ (not shown in the figures).

The above is only a preferred embodiment of the present application, and thus does not limit the protection scope of the present application. Any equivalent structure or equivalent process transformation of the specification and the drawings of the present application, or directly or indirectly applied to other related technical fields, should be included in the protection scope of the present application.

What is claimed is:

1. A driving device of a display panel, comprising:
a system-on-chip, configured to receive an image data signal to be transmitted and to output the image data signal to be transmitted;
a timing controller, configured to receive the image data signal to be transmitted output from the system-on-chip, and to extend and output the image data signal to be transmitted; the timing controller being further configured to produce a control signal for controlling a gate driver and output the control signal; and
the gate driver and a source driver; wherein the gate driver is configured to turn on simultaneously a plurality of scanning lines according to the control signal; the source driver is configured to drive respectively a pixel unit connected with the plurality of the turned-on scanning lines according to the extended image data signal, allowing the extended image data signal to be displayed after column extension.

2. The driving device of claim 1, wherein, the timing controller is configured to receive the image data signal to be transmitted output from the system-on-chip, and to output the image data signal to be transmitted after line extension.

3. The driving device of claim 2; wherein, the timing controller comprises: a line extraction module, configured to extract data of each line of the image data signal to be transmitted, when the image data signal to be transmitted is received.

4. The driving device of claim 3, wherein, the timing controller further comprises: an extension module, configured to process line extension to data of each line of the extracted image data signal to be transmitted.

5. The driving device of claim 4, wherein, the extension is carried out to the data of each line of the extracted image data signal by the extension module via copying or interpolating.

6. The driving device of claim 5, wherein, double extension is carried out to the data of each line of the extracted image data signal by the extension module via copying or interpolating.

7. The driving device of claim 1, wherein, the gate driver is further configured to turn on simultaneously two scanning lines according to the control signal.

8. The driving device of claim 7, wherein, the gate driver is further configured to turn on simultaneously two adjacent scanning lines.

9. The driving device of claim 7, wherein, the scanning lines are a plurality of scanning line pairs that are arranged in sequence.

10. The driving device of claim 1, wherein, the system-on-chip is further configured to receive an image signal; to convert the image signal in a format compatible for the time controller, and to output the image signal to the time controller.

11. A driving method of a display panel, comprising:
receiving an image data signal to be transmitted by a system-on-chip and outputting the image data signal to be transmitted;
receiving the image data signal to be transmitted output from the system-on-chip by a timing controller, extending and outputting the image data signal to be transmitted; wherein the timing controller produces a control signal to control a gate driver and outputs the control signal;
turning on simultaneously a plurality of scanning lines according to the control signal by the gate driver; driving respectively a pixel unit connected with the turned-on scanning lines according to the extended image data signal by the source driver, allowing the extended image data signal to be displayed after line extension and column extension.

12. The driving method of claim 11, wherein, receiving the image data signal to be transmitted output from the system-on-chip by a timing controller, outputting the image data signal to be transmitted after extension, specifically comprises:
receiving the image data signal to be transmitted output from the system-on-chip by the time controller, and outputting the image data signal to be transmitted after line extension.

13. The driving method of claim 11, wherein, receiving the image data signal to be transmitted output from the system-on-chip by a timing controller, outputting the image data signal to be transmitted after extension, specifically comprises:
extracting data of each line of the image data signal to be transmitted by the timing controller, when the image data signal to be transmitted is received by the timing controller.

14. The driving method of claim 13, wherein, the timing controller comprises an extension module;
receiving the image data signal to be transmitted output from the system-on-chip by the time controller, and outputting the image data signal to be transmitted after extension, specifically comprises:
processing extension to data of each line of the extracted image data signal to be transmitted by the extension module.

15. The driving method of claim 14, wherein, processing extension to the data of each line of the extracted image data signal to be transmitted by the extension module, comprises:
processing double extension to the data of each line of the extracted image data signal to be transmitted by the extension module.

16. The driving method of claim 11, wherein, turning on simultaneously a plurality of scanning lines according to the control signal by the gate driver, specifically comprises:
turning on simultaneously two scanning lines according to the control signal by the gate driver.

17. The driving method of claim 16, wherein, turning on simultaneously two scanning lines according to the control signal by the gate driver, specifically comprises:
turning on simultaneously two adjacent scanning lines according to the control signal by the gate driver.

18. The driving method of claim 16, wherein, before the step of turning on simultaneously two scanning lines according to the control signal by the gate driver, the method comprises:
enabling the scanning lines to be a plurality of scanning line pairs that are arranged in sequence.

19. The driving method of claim 11, wherein, receiving the image data signal to be transmitted output from the system-on-chip by a timing controller, outputting the image data signal to be transmitted after extension, specifically comprises:
receiving an image signal, converting the image signal in a format compatible for the time controller, and outputting the image signal to the time controller by the system-on-chip.

20. A driving method, comprising:
receiving a full high definition image data signal by a system-on-chip and outputting the full high definition image data signal to be transmitted;
receiving the full high definition image data signal output from the system-on-chip by the timing controller, extracting data of each line of the full high definition image data signal, and calling for an extension module; transmitting the data of each line of the full high definition image data signal to the extension module, so that the data of each line of the full high definition image data is output after double extension by the extension module via copying and interpolating; wherein the timing controller produces a control signal for controlling the gate driver and outputs the control signal;
turning on simultaneously two adjacent scanning lines according to the control signal by the gate driver; driving respectively a pixel unit connected with the turned-on two adjacent scanning lines according to the full high definition image data signal after line extension by the source driver, so that the full high definition image data signal is displayed as an ultra high definition image data signal after the line extension.
